(19) United States
(12) Patent Application Publication
(10) Pub. No.: US 2009/0233018 A1
(43) Pub. Date: Sep. 17, 2009

(54) INKJET RECORDING MEDIUM AND PROCESS FOR MANUFACTURING THE SAME

(75) Inventor: Shigehisa Tamagawa, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/720,980

(22) PCT Filed: Dec. 6, 2005
(86) PCT No.: PCT/JP05/22730

§ 371 Date: Jun. 6, 2007

(30) Foreign Application Priority Data
Dec. 9, 2004 (JP) 2004-356931

(51) Int. Cl. B41M 5/52; B05D 3/12

(52) U.S. Cl. 428/32.38; 427/361; 428/32.1

(57) ABSTRACT

An object of the present invention is to provide an inkjet recording medium which has an excellent ink absorbability, suppresses an ink blur, and has an improved surface glossiness, and a process for manufacturing the medium.

The invention provides a process for manufacturing an inkjet recording medium having an ink image-receiving layer having a porous structure on at least one surface of a support, in which the process comprises forming an ink image-receiving layer having a porous structure on at least one surface of the support, and calendar-treating the support having the ink image-receiving layer with a long nip calendar comprising a metal roll and a shoe roll, and a synthetic resin belt therebetween and having a nip width of 10 mm or more. The invention also provides an inkjet recording medium manufactured by the process.

### TECHNICAL FIELD

The present invention relates to an inkjet recording medium and a process for manufacturing the same, and more particularly, to an inkjet recording medium which suppresses ink blur, has better gloss feeling, and is suitable for forming clear image quality and a process for manufacturing the same.

### BACKGROUND ART

In recent years, with rapid development of the information technology (IT) industry, various information processing systems have been developed, and recording methods and recording apparatuses suitable for respective information processing systems have been also developed and put into practice. Among the recording methods, since an inkjet recording method has advantages in that it can record on many kinds of recording materials, and in that hardware (apparatus) is relatively inexpensive, compact and quiet, the method is widely used in offices, of course, and also in so-called home use.

In addition, with increase in the resolution degree of inkjet printers in recent years, it has become possible to obtain a so-called photograph-like high image quality recorded article. Along with such further development in hardware (apparatus), recording sheets for inkjet recording have been variously improved. Examples of properties required for a recording sheet for inkjet recording generally include properties such that (1) the sheet has quick-drying property (an ink absorbing rate is high), (2) a diameter of an ink dot is proper and uniform (there is no blur), (3) granularity is good, (4) a dot has a high circularity, (5) color density is high, (6) color saturation is high (there is no color dullness), (7) light fastness and water resistance at a printed part are good, (8) brightness of a recording sheet is high, (9) storability of a recording sheet is good (yellowing and coloring are not caused during long term storage, and an image is not blurred during long term storage), (10) a recording sheet is not easily deformed and has good dimensional stability (curl is sufficiently small), and (11) running property in hardware is better. Further, in use of a photo glossy paper used for the purpose of obtaining a so-called photograph-like high image quality recorded article, in addition to the aforementioned properties, glossiness, surface smoothness, and photographic paper-like texture similar to that of a silver salt photograph are required.

In addition, in recent years, distribution of write-once read-many and rewritable optical information recording media such as CD-R, CD-RW, DVD-R and the like has been remarkable, and many media in which an ink receiving layer is provided on a label side thereof have also been developed.

Further, for the purpose of improving the aforementioned various properties, in recent years, an inkjet recording sheet having an ink receiving layer having a porous structure has been developed and put to practical use. The inkjet recording sheet having an ink receiving layer having a porous structure is excellent in ink absorbability and can suppress ink blur.

On the other hand, a method of improving glossiness of a surface by calendar-treating an inkjet recording medium has been proposed. For example, an inkjet recording sheet using a calendar-treated support (base paper) (for example, see Patent Reference 1), and a support for a recording material in which a base paper is treated with a long nip calendar (for example, see Patent Reference 2) have been proposed, and these improve glossiness of a surface. In addition, an inkjet recording sheet in which an ink image-receiving layer on a support is treated with a soft calendar (for example, see Patent Reference 3), an inkjet recording sheet in which an ink image-receiving layer on a support with a polyolefin layer formed thereon is treated with a supercalendar or a gloss calendar (for example, see Patent Reference 4), and an inkjet recording material (for example, see Patent Reference 5) have been proposed.

However, among the above proposals, in the inkjet recording sheets and inkjet recording materials of Patent References 1 and 3 to 5, although gloss of a surface is improved, porosity of an ink image-receiving layer is lost, and ink absorbability is reduced. In addition, as for the support of Patent Reference 2, ink absorbability is not mentioned.

[Patent Reference (1)] Japanese Patent Application Laid-Open (JP-A) No. 6-171204

[Patent Reference (2)] JP-A No. 2000-314941

[Patent Reference (3)] JP-A No. 11-268405

[Patent Reference (4)] JP-A No. 2001-171225

[Patent Reference (5)] JP-A No. 2004-130671

### DISCLOSURE OF THE INVENTION

The present invention is aimed at solving the aforementioned various problems in the prior art and attaining the following objects.

An object of the invention is to provide an inkjet recording medium which is excellent in ink absorbability, suppresses an ink blur, and has improved surface glossiness, and a process for manufacturing the same.

<1> A process for manufacturing a inkjet recording medium having an ink image-receiving layer having a porous structure on at least one surface of a support, comprising forming the ink image-receiving layer having a porous structure on at least one surface of the support, and subjecting the support having the ink image-receiving layer to a calendar treatment by the use of a long nip calendar comprising a metal roll and a shoe roll, with a synthetic resin belt therebetween and having a nip width of 10 mm or more.
<2> The process for manufacturing an inkjet recording medium according to <1>, wherein the ink image-receiving layer contains ammonium zirconium carbonate.
<3> The process for manufacturing an inkjet recording medium according to <1> or <2>, wherein the support is a paper support in which the both surfaces of a base paper are coated with a polyolefin resin.
<4> The process for manufacturing an inkjet recording medium according to <3>, wherein the polyolefin resin on at least one surface of the support on which the ink image-receiving layer is provided is a resin containing 50% by mass or more of polypropylene.
<5> The process for manufacturing an inkjet recording medium according to any one of <1> to <4>, wherein a surface temperature of the side of the metal roll which is brought into contact with the ink image-receiving layer when the calendar treatment is performed is from 50 to 170° C.
<6> The process for manufacturing an inkjet recording medium according any one of <1> to <5>, wherein the nip width is 20 mm or more, the polyolefin resin is a resin containing 50% by mass or more of polypropylene, a surface temperature of the side of the metal roll which is brought contact with the ink image-receiving layer when the calendar treatment is performed is from 80 to 170° C., and a nip pressure between the metal roll and the shoe roll is from 50 to 300 kN/m.
<7> The process for manufacturing an inkjet recording medium according to any one of <1> to <5>, wherein the nip width is 10 mm or more, the polyolefin resin is a resin containing 50% by mass or more of polypropylene, the surface temperature of the side of a metal roll which is brought contact with the ink image-receiving layer when the calendar treatment is performed is from 100 to 170° C., and a nip pressure between the metal roll and the shoe roll is from 50 to 300 kN/m.
<8> An inkjet recording medium, manufactured by a process for manufacturing an inkjet recording medium as defined in any one of <1> to <7>.
According to the invention, an inkjet recording medium which is excellent in ink absorbability, suppresses an ink blur, and has improved surface glossiness and a process for manufacturing the same can be provided.

### BRIEF DESCRIPTION OF THE DRAWINGS

FIG. 1 is a schematic illustration view showing one embodiment of a long nip calendar.

FIG. 2 is a schematic illustration view showing another embodiment of a long nip calendar.

### BEST MODE FOR CARRYING OUT THE INVENTION

The inkjet recording medium of the invention is an inkjet recording medium having an ink image-receiving layer of a porous structure on at least one surface of a support, characterized in that the medium is manufactured by forming an ink image-receiving layer of a porous structure on at least the one surface of the support, and calendar-treating the support with a long nip calendar consisting of a metal roll and a shoe roll via a synthetic resin belt and having a nip width of 10 mm or more.

### <Support>

As a support in the invention, any of a transparent support comprising a transparent material such as a plastic and the like, and an opaque support consisting of an opaque material such as a paper and the like can be used. For utilizing transparency of an ink image-receiving layer, it is preferable to use a transparent support or an opaque support having a high glossiness. In addition, in the invention, an inkjet recording medium of the invention can be manufactured by forming an ink image-receiving layer on a label surface side using, as a support, a read only optical disk such as CD-ROM, DVD-ROM and the like, a write-once read-many optical disk such as CD-R, DVD-R and the like, or a rewritable optical disk.

As a material usable in the transparent support, a material which is transparent, and has a nature of enduring radiation heat when it is used in OHP or back light display is preferable. Examples of the material include polyesters such as polyethylene terephthalate (PET) etc.; polysulfone, polyphenylene oxide, polyimide, polycarbonate, polyamide and the like. Inter alia, polyesters are preferable and polyethylene terephthalate is particularly preferable.

A thickness of the transparent support is not particularly limited, but is preferable from 50 to 200 μm from the viewpoint of easy handling.

As an opaque support having a high glossiness, the surface of a support on which an ink image-receiving layer is provided, has preferably a gloss value of 40% or higher. The gloss value is a value obtained according to the method described in JIS P-8142 (Method of testing a 75 degree specular gloss value of paper and paperboard). Specifically, the following support is exemplified.

Examples include a paper support having a high glossiness such as an art paper, a coat paper, a cast coat paper, a barayta paper used in a support for a silver salt photographic material and the like, etc.; a film having a high glossiness obtained by making opaque by introducing a white pigment in a plastic film of polyesters such as polyethylene terephthalate (PET) and the like, cellulose esters such as nitrocellulose, cellulose acetate, cellulose acetate butyrate and the like, polysulfone, polyphenylene oxide, polyimide, polycarbonate, polyamide and the like (which may be surface calendar-treated); a support in which a polyolefin overcoat layer containing or not containing a white pigment is provided on a surface of the transparent support of a film having a high glossiness containing a white pigment, and the like.

Preferable examples include a white pigment-containing foamed polyester film (e.g. foamed PET containing polyolefin fine particles, in which voids are formed by stretching. Further, a resin coat paper used in a photographic paper for a silver salt photographic material is also preferable.

A thickness of the opaque support is also not particularly limited, but 50 to 300 μm is preferable from the viewpoint of handling property.

In addition, in order to improve wetting property and adhesion property, a surface of the support may be subjected to a corona discharge treatment, glow discharge treatment, flame treatment, ultraviolet-ray irradiation treatment or the like.

Then, a base paper used in the resin coat paper will be described in detail.

The aforementioned base paper is made using a woodpulp as a main raw material and, if necessary, using a synthetic pulp such as polypropylene, or a synthetic fiber such as nylon or polyether in addition to the woodpulp. As the woodpulp, any of LBKP, LBSP, NBKP, NBSP, LDP, NDP, LUKP and NUKP may be used, and it is preferable to use in a lager amount of LBKP, NBSP, LBSP, NDP or LDP containing a short fiber in a large amount. A content of LBSP and/or LDP is preferably 10% by mass or more and 70% by mass or less.

As the pulp, a chemical pulp having little impurity (sulfate pulp and sulfite pulp) is preferably used, and a pulp, a brightness of which is improved by a bleaching treatment, is also useful.

A sizing agent such as higher fatty acid, alkyl ketene dimer and the like, a white pigment such as calcium carbonate, talc, and titanium oxide, a paper strength-enhancing agent such as starch, polyacrylamide, polyvinyl alcohol and the like, a fluorescent brightener, a moisture retaining agent such as polyethylene glycols and the like, a dispersant, and a softening agent such as quaternary ammonium and the like can be appropriately added to the base paper.

As a freeness of a pulp used for making a paper, 200 to 500 ml defined in CSF is preferable and, as a fiber length after beating, a sum of a 24 mesh remaining mass % and a 42 mesh remaining mass % defined in JIS P-8207 is preferably 30 to 70%. It is preferable that 4 mesh remaining mass % is 20% by mass or less.

A basis weight of a base paper is preferably 30 to 250 g, particularly preferably 50 to 200 g. A thickness of a base paper is preferably 40 to 250 μm. A high smoothness may be imparted to a base paper by calendar treating at a paper making stage or after paper making. A base paper density is generally 0.7 to 1.2 g/m² (JIS P-8118). Further, a base paper stiffness is preferably 20 to 200 g under the condition prescribed in JIS P-8143.

A surface sizing agent may be coated on a base paper surface and, as the surface sizing agent, the same sizing agent as the sizing agent which can be added to a base paper can be used.

A pH value of a base paper is preferably 5 to 9 when it is measured by a hot water extracting method prescribed in JIS P-8113.

As a resin for coating on the front and back surfaces of a base paper, polyolefin is preferable and, as the polyolefin, a homopolymer such as polyethylene, polypropylene, polybutene, polypentene and the like; a copolymer consisting of two or more α-olefins such as an ethylene-butylene copolymer and the like, and a mixture thereof are preferably used. In the invention, it is preferable that, at least, a polyolefin resin on the surface of a support on which an ink image-receiving layer is provided is a resin containing polypropylene in an amount of 50% or more by mass.

In the polyolefin resin on the surface of a support on which an ink image-receiving layer is provided, a content of polypropylene is preferably 50 to 90% by mass, further preferably 50 to 80% by mass from the viewpoint of manufacturing suitability in melt extrusion and occurrence of blister during calendaring treatment. As a resin to be mixed with polypropylene, polyethylene is preferable.

A thickness of a polyolefin layer for coating on the front and back surfaces of a base paper is usefully 4 to 100 μm, and is preferably 6 to 50 μm, particularly preferably 9 to 35 μm.

It is preferable that the polyolefin resin contains titanium dioxide for the purpose of enhancing an image resolution. Examples of the titanium dioxide include various titanium dioxides such as titanium oxide obtained by a sulfuric acid method, titanium dioxide obtained by a chlorine method, rutile type titanium dioxide, anatase type titanium dioxide, titanium dioxide having a surface treated with a hydrous metal oxide, titanium dioxide having a surface treated with an organic compound, and the like.

As a method of coating a polyolefin resin on the front and back surfaces on base paper, any method may be used and, inter alia, from the viewpoint of planarity, a method of covering by a so-called melt extrusion coating method, in which a resin or a resin composition containing an additive is cast on a running substrate paper as a layer using a melt extruder through a die slit, or a method of laminating a polyolefin resin obtained by forming a resin or a resin composition containing an additive as a layer on both surfaces of the substrate paper using a dry lamination apparatus is preferable.

The polyolefin resin may contain various additives. Examples of the additive include, in addition to the aforementioned titanium dioxide, a white pigment such as zinc oxide, talc, calcium carbonate and the like; a dispersant for a titanium dioxide pigment and other pigment; fatty acid amide such as stearic acid amide, arachidic acid amide and the like, and an aliphatic acid metal salt such as zinc stearate, calcium stearate, aluminum stearate, magnesium stearate, zinc palmitate, zinc myristate, calcium palmitate and the like as a releasing agent; various antioxidants such as a hindered phenol, hindered amine, phosphorus type antioxidant, sulfur type antioxidant and the like described in JP-A No. 1-105245; a blue pigment or dye such as cobalt blue, ultramarine, cerulean blue, phthalocyanine blue and the like; a magenta pigment or dye such as cobalt violet, fast violet, manganese violet and the like; a quinacridone-based reddish pigment described in JP-B No. 4-2175; fluorescent brightener, ultraviolet-ray absorbing agent and the like described in JP-A No. 2-254440, and these may be contained appropriately in combination.

It is preferable that the additive is contained in a resin composition for forming a layer forming resin, or is contained as a separately prepared master batch or compound of a resin.

### <Ink Image-Receiving Layer>

The ink image-receiving layer is an ink image-receiving layer having a porous structure, is preferably contain at least inorganic pigment fine particles having an average primary particle diameter of 20 nm or smaller, a water-soluble resin, a mordant, and a crosslinking agent and, if necessary, may contain other component such as a light fastness improving agent and the like. In addition, in a preferred embodiment the ink image-receiving layer is preferably formed on a substrate by a WOW method as described later. In the invention, the ink image-receiving layer having a porous structure refers to an ink image-receiving layer comprising a translucent porous layer having an average pore diameter of 30 nm or smaller and a void ratio of 50% or more in which inorganic pigment fine particles form a three-dimensional network structure.

### (Inorganic Pigment Fine Particles)

In the inkjet recording medium of the invention, inorganic fine particles are used in order to form a porous structure in the ink image-receiving layer. Thus, the ink image-receiving layer has a porous structure, so that an ink absorbing performance can be improved. In particular, when a solid content of inorganic fine particles in an ink image-receiving layer exceeds 50% mass or more, more preferably 60% by mass, it becomes possible to form a further better porous structure, and the inkjet recording medium having sufficient ink absorbability can be obtained. Herein, the solid content of inorganic fine particles in an ink image-receiving layer is a content calculated based on components other than water in a composition constituting an ink image-receiving layer.

It is preferable that the ink image-receiving layer contains anhydrous inorganic pigment fine particles having an average primary particle diameter of 20 nm or smaller. Examples of the inorganic pigment fine particles include silica fine particles, colloidal silica, titanium dioxide, barium sulfate, calcium silicate, zeolite, kaolinite, halloysite, mica, talc, calcium carbonate, magnesium carbonate, calcium sulfate, boehmite, pseudoboehmite and the like. Inter alia, silica fine particles is particularly preferable.

Since the silica fine particles have a particularly large specific surface area, a high absorbability and retaining property of an ink is high and, since the silica fine particles have a low refractive index, when the particles are dispersed to a suitable particle diameter, a high transparency can be imparted to an ink image-receiving layer to obtain the feature of a high color density and better color forming property. The transparency of an ink image-receiving layer is important not only for use in an OHP or the like which needs a transparency, but also for use in a recording sheet such as a photo gloss paper and the like, from the viewpoint of obtaining a high color density and better color forming property.

An average primary particle of the inorganic pigment fine particles is further more preferably 10 nm or smaller, most preferably 3 to 10 nm.

Since the silica fine particles have a silanol group on the surface thereof, and the particles are easily adhered to each other by hydrogen bonds due to the silanol group, a structure having a large void ratio can be formed when an average primary particle diameter is 10 nm or smaller as described above, and ink absorbing property can be effectively improved.

In addition, silica fine particles is roughly classified into wet process particles and dry process particles depending on processes for preparing particles.

In the wet process, a method of producing active silica by acidrolysis of silicate, and appropriately polymerizing and aggregation-sedimenting thereof to obtain hydrous silica is generally used. On the other hand, in the dry process, a method of obtaining anhydrous silica by a process of a high temperate vapor phase hydrolysis of silicon halide (flame hydrolysis method), or a process of heating-reducing and vaporizing silica sand and coke with an arc in an electric furnace, and oxidizing thereof with air (arc method) is generally used.

Hydrous silica and anhydrous silica obtained by these methods differ from one another in densities of silalol groups on the surface thereof, and the presence or the absence of pores and the like, and exhibit different natures. In the case of anhydrous silica (silicic acid anhydride), it is particularly preferable that a three-dimensional structure having a particularly high void ratio is easily formed. Although the reason is not clear, it is presumed that, in the case of hydrous silica, a density of a silanol group on fine particle surface is high such as 5 to 8/nm², silica fine particles are easily densely aggregated and, on the other hand, in the case of anhydrous silica, a density of a silanol group on a fine particle surface is low such as 2 to 3/nm , a sparse soft flocculate is formed and, as a result, a structure having a high void ratio is formed.

Therefore, in the invention, it is preferable that silica (silica fine particles) having a density of a silanol group on a fine particle surface of 2 to 3/nm² is used.

From the viewpoint of transparency, the kind of resins to be combined with silica fine particles are important and, when anhydrous silica is used, the water-soluble resin is preferably polyvinyl alcohol (PVA), inter alia, PVA having a saponification degree of 70 to 99% is more preferably, and PVA having a saponificaiton degree of 70 to 90% is most preferable.

The PVA has a hydroxyl group in its structural unit, and this hydroxyl group and a silanol group on a silica fine particle surface form a hydrogen bond, so that a three-dimensional network structure having secondary particles of silica fine particles as a chain unit is easily formed. It is thought that, by the formation of the three-dimensional network structure, an ink image-receiving layer of a porous structure having a high void ratio can be formed.

The thus obtained porous ink image-receiving layer absorbs rapidly an ink by capillary phenomenon, and can form a spot having a high roundness which does not cause an ink blur, in an inkjet recording.

A content ratio of inorganic pigment fine particles (preferably silica fine particles; (i) and a water-soluble resin (p) [P to B ratio (i:p), a weight of inorganic pigment fine particles relative to 1 part by weight of a water-soluble resin] greatly influences also on a layer structure of an ink image-receiving layer. That is, as a P to B ratio increases, a void ratio, a pore volume, and a surface area (per unit weight) increases.

Specifically, as the P to B ratio (i:p), 1.5:1 to 10:1 is preferable. When the P to B ratio exceeds 10:1, that is, the P to B ratio becomes too large, a layer strength is lowered and cracks are easily generated during drying in some cases. When the ratio is less than 1.5:1, that is, a P to B ratio is too small, a void clog easily with a resin, as a result, the void ratio decreases, and ink absorbability is reduced in some cases.

Since when a recording sheet passes through a conveying system of an inkjet printer, a stress may be applied to the sheet, the ink image-receiving layer is necessary to have a sufficient layer strength. Further, when a sheet is fabricated into a sheet form, the ink image-receiving layer is necessary to have a sufficient layer strength in order to prevent the ink image-receiving layer from cracking, peeling off or the like.

In this case, the P to B ratio is preferably 5:1 or smaller and, from the viewpoint of maintaining a high ink absorbing speed in an inkjet printer, 2:1 or more is preferable.

For example, when a coating solution in which inorganic silica fine particles having an average primary particle diameter of 20 nm or smaller and a water-soluble resin are completely dispersed in an aqueous solution at a P to B ratio of 2:1 to 5:1 is coated on a substrate, and the coated layer is dried, a three-dimensional network structure containing secondary particles of silica fine particles as a chain unit is formed, and a translucent porous layer having an average pore diameter of 30 nm or smaller, a void ratio of 50% or greater, a pore specific volume of 0.5 ml/g or more, and a specific surface area of 100 m²/g or greater can be easily formed.

### (Water-Soluble Resin)

Examples of the water soluble resin include polyvinyl alcohol (PVA), cationic modified polyvinyl alcohol, anionic modified polyvinyl alcohol, silanol-modified polyvinyl alcohol, polyvinyl acetal, cellulose-based resin [methylcellulose (MC), ethylcellulose (EC), hydroxyethylcellulose (HEC), carboxymethylcellulose (CMC) etc.], chitins, chitosans, and starch which are a resin having a hydroxyl group as a hydrophilic structural unit; polyethylene oxide (PEO), polypropylene oxide (PPO), polyethylene glycol (PEG), and polyvinyl ether (PVE) which are a resin having an ether bond; polyacrylamide (PAAM), and polyvinylpyrrolidone (PVP) which are a resin having an amido group or an amido bond, and the like.

Other examples include polyacrylic acid salt, maleic acid resin, alginic acid salt, and gelatins. Among them, polyvinyl alcohols are particularly preferable.

A content of the water-soluble resin is preferably 9 to 40% by mass, more preferably 16 to 33% by mass relative to a weight of a total solid matter of an ink image-receiving layer. When a content of the water-soluble resin is 9 to 40% by mass, reduction in a layer strength, and crack during drying are not easily caused, and the ink absorbability is not reduced due to clogging of voids with a resin and, reduction in the void ratio.

Each of the inorganic pigment fine particles and water-soluble resin mainly constituting an ink image-receiving layer may be a single material, respectively, or may be a mixed system of a plurality of materials, respectively.

### (Mordant)

As a mordant, a cationic polymer (cationic mordant) can be used and, the mordant in the ink image-receiving layer interacts with a liquid ink containing an anionic dye as a coloring material to stabilize the coloring material, and water resistance and blur of the ink with time can be improved.

However, when the mordant is added directly to a coating solution for forming an ink image-receiving layer, the is a fear of generating aggregation between the mordant and inorganic pigment fine particles having an anion charge such as silica and the like is caused in some cases, but by utilizing a method of preparing and coating the mordant as an independently separate solution, the is no fear that aggregation of inorganic pigment fine particles take place. Therefore, in the invention, it is preferable to use a crosslinking solution containing the mordant described below.

As the cationic mordant, a polymer mordant having a primary to tertiary amino group, or a quaternary ammonium salt as a cationic group is preferably used, and a cationic non-polymer mordant may be also used.

As the polymer mordant, polymer mordents obtained as a homopolymer of a monomer (mordant monomer) having a primary to tertiary amino group and a salt thereof, or a quaternary ammonium salt, and a copolymer or a condensed polymer of the mordant monomer and other monomer (hereinafter, also referred to as “non-mordant polymer”) are preferable. And, these polymer mordents can be used in any form of a water-soluble polymer, and water-dispersible latex particles.

Examples of the monomer (mordent monomer) include a quaternary entity from methyl chloride, ethyl chloride, methyl bromide, ethyl bromide, methyl iodide or ethyl iodide of trimethyl-p-vinylbenzylammonium chloride, trimethyl-m-vinylbenzylammonium chloride, triethyl-p-vinylbenzylammonium chloride, triethyl-m-vinylbenzylammonium chloride, N, N-dimethyl-N-ethyl-N-p-vinylbenzylammonium chloride, N—N-diethyl-N-methyl-N-p-vinylbenzylammonium chloride, N, N-dimethyl-N-n-propoyl-N-p-vinylbenzylammonium chloride, N, N-dimethyl-N-n-octyl-N-p-vinylbenzylammonium chloride, N, N-dimethyl-N-benzyl-N-p-vinylbenzylammonium chloride, N, N-diethyl-N-benzyl-N-p-vinylbenzylammonium chloride, N, N-dimethyl-N-(4-methyl)benzyl-N-p-vinylbenzylammonium chloride, N, N-dimethyl-N-phenyl-N-p-vinylbenzylammonium chloride,

trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N, N-triethyl-N-2-(4-vinylphenyl)ethylammonium chloride, N,N, N-triethyl-N-2-(3-vinylphenyl)ethylammonium chloride, N, N-diethyl-N-methyl-N-2-(4-vinylphenyl)ethylammonium chloride, N, N-diethyl-N-methyl-N-2-(4-vinylphenly)ethylammonium acetate, N,N-dimethylaminoethyl (meth)acrylate, N,N-diethlyaminoethyl(meth)acrylate, N,N-dimethylaminopropyl (meth)acrylate, N,N-diethylaminopropyl(meth)acrylate, N, N-dimethylaminoethyl(meth)acrylamide, N,N-diethylaminoethyl(meth)acrylamide, N, N-dimethylaminopropyl(meth)acrylamide, N,N-diethylaminopropyl(meth)acrylamide, or a sulfonic acid salt, an alkylsulfonic salt, an acetic acid salt or an alkylcarboxylic acid salt in which an anion thereof is substituted.

Specifically, examples include trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, triethyl-3-(acryloylamino)propylammonium chloride, N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, tridimethyl-2-(methacryloyloxy)ethylammonium bromide, tridimethyl-3-(acryloylamino)propylammonium bromide, tridimethyl-2-(methacryloyloxy)ethylammonium sulfonate, tridimethyl-3-(acryloylamino)propylammonium acetate and the like. In addition, examples of a copolymerazable monomer include N-vinylimidazole, N-vinyl-2-methylimidazole and the like.

The non-mordant polymer refers to a monomer which does not contain a basic or cationic part such as a primary to tertiary amino group and a salt thereof, and a quaternary ammonium salt, and does not exhibit an interaction with a dye in an inkjet ink, or has substantially a small interaction.

Examples of the non-mordant monomer include (meth)acrylic acid alkyl ester; (meth)acrylic acid cycloalkylester such as cyclohexyl(meth)acrylate and the like; (meth)acrylic acid aryl ester such as phenyl(meth)acrylate and the like; aralkylester such as benzyl(meth)acrylate and the like; aromatic vinyls such as styrene, vinyltoluene, α-methylstyrene and the like; vinylesters such as vinyl acetate, vinyl propionate, vinyl versatate and the like; allylesters such as allylacetate and the like; halogen containing monomer such as vinylidene chloride, vinyl chloride and the like; vinylcyanide such as (meth)acrylonitrile and the like; olefins such as ethylene, propylene and the like.

As the (meth)acrylic acid alkyl ester, (meth)acrylic acid alkyl ester which has preferably 1 to 18 carbon atoms in an alkyl moiety, and examples include methyl (meth)acrylate, ethyl(meth)acrylate, propyl(meth)acrylate, isopropyl(meth)acrylate, N-butyl (meth)acrylate, isobutyl(meth)acrylate, t-butyl(meth)acrylate, hexyl(meth)acrylate, octyl (meth)acrylate, 2-ethylhexyl(meth)acrylate, lauryl(meth)acrylate, stearyl(meth)acrylate and the like. Among these, methyl acrylate, ethyl acrylate, methyl methacrylate, ethyl methacrylate, and hydroxyethyl methacrylate are preferable.

The non-mordant monomers can be used alone, or in combination with two or more kinds of monomers

Further, preferable examples of a polymer mordant include polydiallyldimethylammonium chloride, polymethacryloyloxyethyl-β-hydroxyethyldimethylammonium chloride, polyethylenimine, polyallylamine, polyallylamine hydrochloride, polyamide-polyamine resin, cationated starch, dicyandiamide formalin condensate, dimethyl-2-hydroxypropylammonium salt polymer, polyamidine, polyvinylamino and the like.

The molecular weight of the polymer mordant is preferably 1000 to 200,000. When the molecular weight of the polymer mordant is 1000 to 200,000, the water resistance is more improved, and handling suitability is not deteriorated due to an excessively high viscosity.

As the cationic non-polymer mordant, a water-soluble metal salt such as aluminum sulfate, aluminum chloride, polyaluminum chloride, magnesium chloride and the like is preferable.

### (Crosslinking Agent)

In the ink image-receiving layer of the inkjet recording medium of the invention, it is preferable that a solution containing at least a crosslinking agent and a mordant (crosslinking agent solution) is further applied to a coating layer (porous layer) containing inorganic pigment fine particles and a water-soluble resin, and the water-soluble resin is cured with the crosslinking agent by a crosslinking reaction.

It is preferable that the application of the crosslinking agent solution is performed at the same time with coating a coating solution (ink image-receiving layer coating solution) for forming the porous ink image-receiving layer, or before a coated layer formed by coating the coating solution for an ink image-receiving layer exhibits a falling rate drying. By this process, cracks generated during drying of a coated layer can be effectively prevented. That is, a crosslinking agent solution permeates into a coated layer at the same time with coating of the coating solution, or before a coated layer exhibits a falling rate drying, and is rapidly reacted with a water-soluble resin in the coated layer to gel (cure) the water-soluble resin, thereby, a layer strength of the coated layer can be instantly improved considerably.

As the crosslinking agent which can crosslink the water-soluble resin, a crosslinking agent suitable in relation to a water-soluble resin used in an inks image-receiving layer may be appropriately selected, inter alia, from the viewpoint of a rapid crosslinking reaction, a boron compound is preferable, and examples include borax, boric acid, borate (e.g. orthoborate, InBO₃, ScBO₃, YBO₃, LaBO₃, Mg₃(BO₃)₂, CO₃(BO₃)₂, diborate (e.g. Mg₂B₂O₅, CO₂B₂O₅), metaborate (e.g. LiBO₂, Ca(BO₂)₂, NaBO₂, KBO₂), tetraborate (e.g. Na₂B₄O₇.10H₂O), pentaborate (e.g. KB₅O₈.4H₂O, Ca₂B₆O₁₁.7H₂O, CsB₅O₅), glyoxal, melamine formaldehyde (e.g. methylol melamine, alkylated methylol melamine), methylolurea, resol resin, polyisocyante, epoxy resin and the like. In particular, from the viewpoint of rapidly causing the crosslinking reaction, borax, boric acid, and borate are preferable, and these are particularly preferable to use in combination with polyvinyl alcohol as a water-soluble resin.

When gelatin is used as a water-soluble resin, the following compound known as a layer curing agent for gelatin can be used as a crosslinking agent. Examples include an aldehyde based compound such as formaldehyde, glyoxal, glutaraldehyde- and like; a ketone based compound such as diacetyl, cyclopentanedione and the like; active halogen compound such as bis(2-chloroethylurea)-2-hydroxy-4,6-dichloro-1,3,5-triazine, 2,4-dichloro-6-S-triazine-sodium salt and the like; active vinyl compound such as divinyl sulfonyl acid, 1,3-vinylsulfonyl-2-propanol, N,N′-ethylenebis(vinylsulfonylacetamide), 1,3,5-triacryloyl-hexahydro-S-triazine and the like; N-methylol compound such as dimethylolurea, methyloldimethyl hydantoin and the like; isocyanate-compound such as 1,6-hexamethylene disocyanate and the like; aziridine-based compound described in U.S. Pat. No. 3,017,280, U.S. Pat. No. 2,983,611; carboxylmide-based compound described in U.S. Pat. No. 3,100,704; epoxy-based compound such as glycerol triglycidyl ether and the like; ethyleneimino-based compound such as 1,6-hexamethylene-N,N′-bisethyleneurea and the like; halogenated carboxyaldehyde-based compound such as mucochloric acid, mucophenoxychloric acid and the like; dioxane-based compound such as 2,3-dihydroxydioxane and the like; chromium alum, potassium alum, zirconium sulfate, chromium acetate and the like.

The crosslinking agents may be used alone, or two or more kinds may be used in combination.

The crosslinking agent solution is prepared by dissolving a crosslinking agent in water or an organic solvent. Concentration of a crosslinking agent in the crosslinking agent solution is preferably 0.05 to 10% by mass, particularly 0.1 to 7% by mass relative to the mass of crosslinking agent solution.

As a solvent constituting a crosslinking agent solution, water is generally used, and the solvent may be an aqueous mixed solvent containing an organic solvent miscible with the water.

As the organic solvent, an organic solvent in which a crosslinking agent is dissolved can be arbitrarily used, and examples include alcohols such as methanol, ethanol, isopropyl alcohol, glycerin and the like; ketones such as acetone, methyl ethyl ketone and the like; esters such as methyl acetate, ethyl acetate and the like; aromatic solvents such as toluene and the like; ethers such as tetrahydrofuran and the like; and halogenated hydrocarbon solvents such as dichloromethane and the like.

### (Other Component)

An ink image-receiving layer in the invention mainly comprises inorganic pigment fine particles and a water-soluble resin, and may contain the following components, if necessary.

For the purpose of suppressing deterioration of a coloring material, various ultraviolet-ray absorbing agent, antioxidant, singlet oxygen quencher and the like may be contained.

Examples of the ultraviolet-ray absorbing agent include a cinnamic acid derivative, benzophenone derivative, benzotriazolylphenol derivative and the like. Examples include butyl-α-cyano-vinylcinnamate, o-benzotriazolephenol, o-benzotriazole-p-chlorophenol, o-benzotriazole-2,4-di-t-butylphenol, o-benzotriazole-2,4-di-t-octylphenol and the like. A hindered phenol compound may be also used as an ultraviolet-ray absorbing agent and, specifically, a phenol derivative in which one or more positions of at least the 2-position and 6-position are substituted with a branched alkyl group is preferable.

In addition, a benzotriazole-based ultraviolet-ray absorbing agent, a salicylic acid-based ultraviolet-ray absorbing agent, a cyanoacrylate-based ultraviolet-ray absorbing agent, an oxalic acid anilide-based ultraviolet-ray absorbing agent and the like may be also used. They are described, for example JP-A Nos. 47-10537, 58-111942, 58-212844, 59-19945, 59-46646, 59-109055, and 63-53544, JP-B Nos. 36-10466, 42-26187, 48-30492, 48-31255, 48-41572, 48-54965, and 50-10726, and U.S. Pat. Nos. 2,719,086, 3,707,375, 3,754,919, and 4,220,711.

A fluorescent brightener may be also used as an ultraviolet-ray absorbing agent, and examples include a coumarin-based fluorescent brightener. Specifically, the fluorescent brightener is described in JP-B Nos. 45-4699, and 54-5324.

Examples of antioxidants include the antioxidants described in EP Nos. 223739, 309401, 309402, 310551, 310552, and 459416, German Patent Publication No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536,

63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361, JP-B Nos. 48-43295, and 48-33212, U.S. Pat. No. 4,814,262, and 4,980,275.

Specifically, examples include
6-ethoxy-1-phenyl-2,2,4-trimethyl-1,2-dihydroquinoline,
6-ethoxy-1-octyl-2,2,4-trimethyl-1,2-dihydroquinoline,
6-ethoxy-1-phenyl-2,2,4-trimethyl-1,2,3,4-tetrahydroquinoline,
6-ethoxy-1-octyl-2,2,4-trimethyl-1,2,3,4-tetrahydroquinoline, nickel cyclohexanoate,
2,2-bis(4-hydroxyphenyl)propane, 1,1-bis(4-hydroxyphenyl)-2-ethylhexane,
2-methyl-4-methoxy-diphenylamine, 1-methyl-2-phenylindole and the like.

The light fastness improving agents may be used alone, or two or more kinds may be used in combination. The light fastness improving agent may be water-solubilized, dispersed or emulsified, or may be contained in microcapsules.

An amount of the light fastness improving agent to be added is preferably 0.01 to 10% by mass of an ink image-receiving layer coating solution.

In addition, for the purpose of enhancing dispersibility of the inorganic pigment fine particles, various inorganic salts, and an acid or an alkali as a pH adjusting agent may be contained.

Further, for the purpose of enhancing coating suitability and surface quality, various surfactants may be contained. For the purpose of suppressing frictional electrification and peeling electrification of the surface, surfactants having an ionic electroconductivity, and metal oxide fine particles having an electronic electroconductivity may be contained. Further, for the purpose of reducing friction property of the surface, various matting agents may be contained.

### —Preparation of Inkjet Recording Medium: WOW Method—

As described above, it is preferable that a mordant and a crosslinking agent are introduced into an ink image-receiving layer at a stage of applying the crosslinking agent solution. That is, it is preferable that an ink image-receiving layer is formed by a method (WOW method; Wet On Wet method) of coating with an ink image-receiving layer coating solution containing inorganic pigment fine particles having an average primary particle diameter of 20 nm or smaller and a water-soluble resin, applying a solution containing a crosslinking agent which can crosslink a water-soluble resin, and a mordant to the coated layer at the same time with the coating, or during drying of the formed coated layer before the coated layer exhibits a falling rate drying, and crosslink-curing the coated layer with the solution coated thereon.

Alternatively, an ink image-receiving layer of an inkjet recording medium of the invention may be obtained by simultaneously coating a coating solution containing inorganic pigment fine particles and a water-soluble resin, and a solution containing a crosslinking agent on a substrate (support) in the state where a barrier solution comprising materials which do not react with the crosslinking agent (provided that a mordant is contained in at least one of a solution containing a crosslinking agent and a barrier solution) is held therebetween.

As described above, in the invention, the water resisting property of an ink image-receiving layer is improved by simultaneously coating a mordant together with a crosslinking agent. That is, when the mordant is added to a coating solution for an ink image-receiving layer, since the mordant is cationic, aggregation may occur in the presence of inorganic pigment fine particles having an anionic charge on a surface thereof. However, when a method of independently preparing a solution containing a mordant and a coating solution for an ink image-receiving layer, and the coating solutions are separately coated, it is not necessary to consider the aggregation of inorganic pigment fine particles, and the scope of selection of a mordant can be widened.

In the invention, the coating solution for an ink image-receiving layer containing at least inorganic pigment fine particles and a water-soluble resin (hereafter “referred to as ink image-receiving layer coating solution”) can be prepared, for example as follows. That is, the coating solution can be prepared by adding silica fine particles having an average primary particle diameter of 20 nm or smaller (e.g. 10 to 20% by mass) into water, dispersing them for 20 minutes (preferably 10 to 30 minutes) using a high speed rotation wet-type colloid mill (e.g. Creamix) manufactured by M•Technique)), for example under the condition at a high speed rotation of 100000 rpm (preferably 5000 to 20000 rpm), adding an aqueous polyvinyl alcohol solution (e.g. so that the weight of PVA becomes about ⅓ of that of silica), and dispersing under the same rotating condition as that described above. The resulting coating solution is a uniformed sol and, by coating this solution on a substrate (support) by the following coating method, an ink image-receiving layer of a porous structure having a three-dimensional network structure can be formed.

If necessary, a surfactant, a pH adjusting agent, an antistatic agent and the like may be added to the ink image-receiving layer coating solution.

In addition, in the invention, from the viewpoint that the glossiness of the surface is further improved, the ink image-receiving layer preferably contains ammonium zirconium carbonate as a layer curing agent aid. The content of ammonium zirconium carbonate in the ink image-receiving layer is preferably 0.01 to 1.0 g/m², more preferably 0.03 to 0.3 g/m².

The ink image-receiving layer coating solution can be coared by the known coating methods by using an extrusion die coater, an air doctor coater, a blade coater, a rod coater, a knife coater, a squeeze coater, a reverse roll coater, a bar coater and the like.

After the ink image-receiving layer coating solution is coated, a crosslinking agent solution is coated onto the coated layer, but the crosslinking agent solution may be coated before the coated layer exhibits a falling rate drying. That is, the ink image-receiving layer is preferably prepared by introducing a crosslinking agent and a mordant after coating of the ink image-receiving layer coating solution while the coated layer exhibits a constant rate drying Herein, “before a coated layer exhibits a falling rate drying” usually refers to a few minutes from immediately after the coating of an ink image-receiving layer, and, during this period, the constant rate drying rate which is the phenomenon that a content of a solvent in the coated layer which has been coated decreases in proportion to the time is observed. The time when the constant rate drying rate is observed is described in Chemical Technology Handbook (P.707-712, published by Maruzen on Oct. 25, 1980).

As described above, after coating of the ink image-receiving layer coating solution, the coated layer is dried until the coated layer exhibits a falling rate drying rate, and the layer is dried generally at 50 to 180° C. for 0.5 to 10 minutes (preferably 0.5 to 5 minutes). The time for this drying naturally varies with the coating amount, and the aforementioned range is generally suitable.

Examples of the coating method for coating a layer before the coated layer exhibits a falling rate drying rate include (1) a method of further coating a crosslinking solution on a coated layer, (2) a method of atomizing by spraying or the like, (3) a method of immersing a substrate (support) on which the coated layer is formed, in a crosslinking agent solution, and the like.

As a coating method of coating a crosslinking agent solution in the aforementioned method (1), the known coating method by using a curtain flow coater, an exclusion die coater, an air doctor coater, a blade coater, a rod coater, a knife coater, a squeeze coater, a reverse roll coater, a bar coater and the like can be utilized. However, as a method in which a coater is not brought into directly contact with the formed coated layer, an extrusion die coater, a curtain flow coater, a bar coater and the like is preferably utilized.

The coating amount of a coating solution containing at least a crosslinking agent and a mordant (crosslinking agent solution), which is imparted on an ink image-receiving layer is generally 0.01 to 10 g/m², preferably 0.05 to 5 g/m² in terms of a crosslinking agent.

After coating the crosslinking agent solution, the coated layer is generally heated at 40 to 180° C. for 0.5 to 30 minutes, and is dried and cured. In particular, the coated layer is preferably heated at 40 to 150° C. for 1 to 20 minutes.

For example, when borax or boric acid is used as a crosslinking agent to be contained in the crosslinking agent solution, it is preferable to perform heating at 60 to 100° C. for 5 to 20 minutes.

Alternatively, the crosslinking agent coating solution may be coated at the same time when the ink image-receiving layer coating solution is coated. In this case, the ink image-receiving layer coating solution can be formed by simultaneously coating (overlaying coating) an ink image-receiving layer coating solution and a crosslinking agent solution containing a crosslinking agent and a mordant on a substrate (support) so that the ink image-receiving layer coating solution is brought into contact with the substrate (support), followed by drying and hardening the layers.

The simultaneous coating (overlaying coating) can be performed by a coating method using, for example, an exclusion die coater, or a curtain flow coater. After the simultaneous coating, the formed coating layer is dried, and in this case the coated layer is dried by heating generally at 40 to 150° C. for 0.5 to 10 minutes, preferably at 40 to 100° C. for 0.5 to 5 minutes. For example, when borax or boric acid is used as a crosslinking agent to be contained in the crosslinking agent solution, the coated layer is preferably heated at 60 to 100° C. for 5 to 20 minutes.

When the simultaneous coating (overlaying coating) is performed, for example, by using an excluding die coater, two kinds of coating solutions which are extruded simultaneously are double-layered in the vicinity of the extruding port of thee extrusion die coater, before the coating solutions are transferred onto a substrate (support) and, thereafter, the double-layered solutions are coated on the substrate (support). The two layers of the coating solutions which have been overlaid prior to the coating, and a crosslinking reaction tends to take place due to mixing the two solutions at the interface of the two solutions at the time when the solutions are transferred onto the substrate (support). so that the extrudes two solutions tend to be thickened at the interface, resulting in the coating operation may become troublesome. Therefore, when simultaneous coating is performed as described above, it is preferable that a simultaneous triple layer coating is performed by using an ink image-receiving layer coating solution and a crosslinking agent solution containing a crosslinking agent and a mordant, and further a barrier layer solution containing materials which do not react with the crosslinking agent (intermediate layer solution) being interposed therebetween.

The barrier layer solution can be selected without any limitation, as far as it does not react with a crosslinking agent and can form a liquid layer. Examples include an aqueous solution containing a water-soluble resin which does not react with a crosslinking agent in a small amount, water and the like. The water-soluble resin is used for the purpose of increasing a viscosity, in light of the coating property, and examples of the water-soluble resin include polymers such as hydroxypropyl methylcellulose, methylcellulose, hydroxyethylmethylcellulose, polyvinylpyrrolidone, gelatin and the like. The mordant may be contained in the barrier layer solution.

The inkjet recording medium of the invention is characterized in that it is manufactured by forming an ink image-receiving layer having a porous structure on at least one surface of a support as described above, and the support is subjected to a calendar-treatment by the use of a long nip calendar comprising a metal roll and a shoe roll via a synthetic resin belt and having a nip width of 10 mm or more.

The shoe roll has an endless belt made of an elastic resin and, if necessary, has other members. The endless belt referred in the invention includes a cylindrical sleeve shape in addition to the endless belt in the general meanings.

It is preferable that the shoe roll is provided with a pressure unit, and a circulation system for circulating a lubricant in addition to the endless belt (sleeve).

The endless belt made of an elastic resin can be formed by using a thick cloth as a support, and covering the support with an elastic resin.

Examples of an elastic resin include an epoxy-based resin, a polyamide-based resin, a polyimide-based resin, a polyimidoamide-based resin, a polyurethane-based resin, a butadiene-based resin, a polyester-based resin, a nylon-based resin, a polyether-based resin and the like. These resins may be used alone, or two or more kinds may be used in combination.

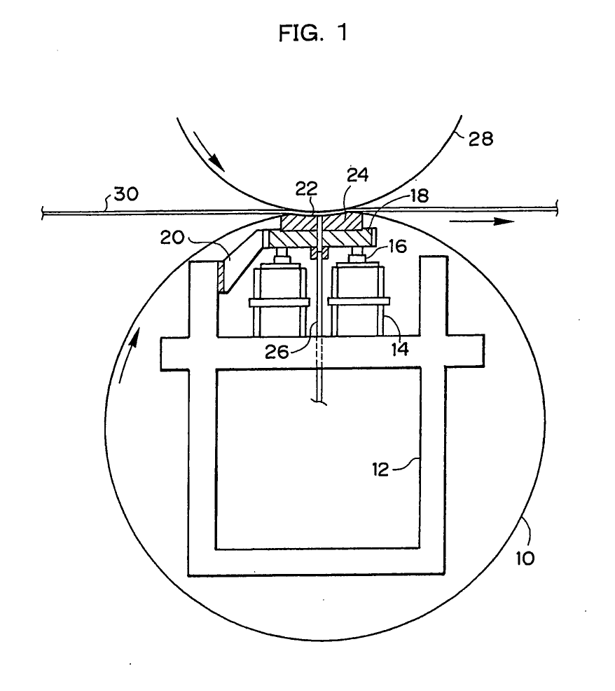

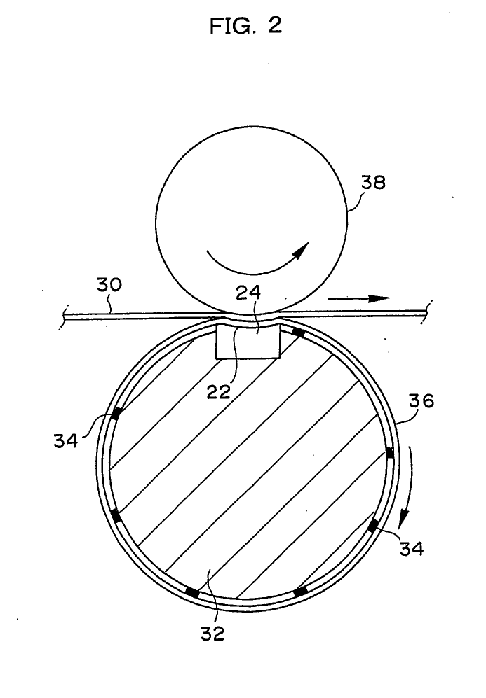

A preferable embodiment of the long nip calendar will be explained with reference to FIG. 1 and FIG. 2. FIG. 1 is a schematic view showing one embodiment of a long nip calendar. FIG. 2 is a schematic view showing another embodiment of a long nip calendar.

In FIG. 1, an endless belt 10 is made of an elastic resin which is liquid impermeable and flexible. A supporting member 12 is disposed within the endless belt 10, and an oil pressure apparatus 14 as a pressurizing unit is mounted on the supporting member 12. A supporting plate 18 is fixed to a piston rod 16 protruding from an upper end of the oil pressure apparatus 14 by screws.

The supporting plate 18 is provided with a support 20 which has a surface slidable on a surface of the supporting member 12, and a press shoe 24 having a concave curved part 22 fixed thereto, and a lubricant supplying apparatus 26 for supplying a lubricant to the concave curved part 22 is provided. In the figure, numeral 28 denotes a metal roll.

In the long nip calendar, in the state where press felt (not shown) are disposed on the both surfaces of an inkjet recording medium 30 having an ink image-receiving layer of a porous structure on at lease one surface of the support, respectively, the metal roll 28 is rotated in the direction of the arrow in FIG. 1 and, at the same time, a lubricant is supplied from a lubricant supplying apparatus 26 to the concave curved part 22 of the press shoe 24, and the press shoe 24 is pushed at a prescribed pressure via the oil pressure apparatus 14. In the calendar treating process, water or the like contained in a web 28 is received and processed by the press felt to a predetermined density.

In FIG. 2, members having substantially the same function as those of the members in FIG. 1 are denoted by the same symbols. In FIG. 2, numeral 32 denotes a constituent part in which an oil pressure apparatus as a pressurizing unit and a lubricating system for circulating a lubricant are provided in a cylindrical securing member as in FIG. 1, guide members 34 are provided at the periphery of the constituent part at predetermined intervals, and a sleeve 36 can rotate around the outer periphery of these guide members 34. In FIG. 2, numeral 38 denotes a metal roll.

In this shoe roll, when the roll is provided between the sleeve 36 and the cylindrical securing member in the constituent part 32 with a gap, friction heat generated when a base paper passes through the nip part is easily released, a high speed operation of the shoe calendar becomes possible, and the lifetime of the sleeve can be extended.

Further, when a cooled lubricating oil is supplied between the cylindrical securing member and the sleeve, the heat releasing action can be further promoted.

As a hardness of the endless belt (sleeve), a Shore hardness on a surface at least at the side which is brought into contact with the inkjet recording medium, is preferably 30 to 80 degree, more preferably 40 to 70 degree.

When the Shore hardness is 30 degree or more, the plastic deformation of the endless belt dose not take place in use, and the lifetime of the shoe roll becomes longer. In addition, a base paper for a photographic paper having a highly smooth and glossy surface can be obtained. On the other hand, when the Shore hardness is 80 degree or less, the hardness of the endless belt does not become too high, a radius of curvature of the shoe roll shape can be easily realized.

The material or the like of the metal roll facing the shoe roll is not particularly limited, but known metal rolls can be appropriately selected and used as long as the roll is a cylindrical or pillar shaped roll having a smooth surface, and has a heating means in an interior thereof. In addition, since the metal roll is brought into contact with a surface to be the front surface of a photographic paper in the both surfaces of a base paper for the photographic paper during the calendar-treatment, the surface roughness of the roll is preferably smoother and, specifically, the surface roughness prescribed in JISB0601 is preferably 0.3 S or less, more preferably 0.2 S or less.

In the invention, the nip width formed by the metal roll and the shoe roll when the inkjet recording medium is subjected to a calendar-treatment by the use of the long nip calendar is 10 mm or more, preferably 20 mm or more, more preferably 20 to 100 mm, still further preferably 30 to 70 mm. When the nip width is less than 10 mm, a time for passing through the nip part of a inkjet recording medium becomes shorter, and the effect of improving glossiness of the surface of the medium cannot be obtained. On the other hand, when the nip width is 100 mm or less, a line pressure applied to the inkjet recording medium during the calendar treatment thereof is sufficiently high, and the calendar treatment effect becomes preferably higher.

In addition, a passing rate when an inkjet recording medium passes through the nip part of the long nip calendar is preferably 30 to 500 m/min, more preferably 50 to 300 m/min, further preferably 100 to 300 m/min. When the passing rate is 30 to 500 m/min, the productivity is high, a time for passage of the inkjet recording medium through the nip part is sufficiently long, and a highly glossy surface can be obtained.

Further, the nip pressure when the inkjet recording medium passes through the nip part of the long nip calendar is preferably 20 to 500 kN/m, more preferably 50 to 300 kN/m, further preferably 50 to 250 kN/m. When the nip pressure is 20 to 500 kN/m, the effects of the invention that an excellent ink absorbability, a suppressed ink blur, and a glossy surface can be obtained become more remarkable.

The surface temperature of the side of the metal roll with which the ink image-receiving layer is brought into contact during the calendar-treatment by the long nip calendar is preferably 50 to 170° C. When the surface temperature of the side of the metal roll with which the ink image-receiving layer is brought into contact is 50 to 170° C., the effects of the invention that an excellent ink absorbability, a suppressed ink blur, and a glossy surface can be obtained become more remarkable. The surface temperature of the side of the metal roll with which the ink image-receiving layer is brought into contact, when the support is a paper support, the both surfaces of which is preferably covered with a resin containing 50% by mass or more of polypropylene, is preferably 80 to 170° C., more preferably 100 to 150° C.

In the invention, it is preferable that, in the aforementioned calendar-treatment by the use of the long nip calendar, the nip width is 20 mm or more, the polyolefin resin is a resin containing 50% by mass or more of polypropylene, a surface temperature of the metal roll with which the ink image-receiving layer is brought into contact during the calendar-treatment is 80 to 170° C., and the nip pressure between the metal roll and the shoe roll is 50 to 300 kN/m.

In addition, in the invention, it is also preferable that, in the aforementioned calendar treatment by the use of the long nip calendar, the nip width is 10 mm or more, the polyolefin resin is a resin containing 50% by mass or more of polypropylene, the surface temperature of the metal roll with which the ink image-receiving layer is brought into contact during the calendar treatment is 100 to 170° C., and the nip pressure between the metal roll and the shoe roll is 50 to 300 kN/m.

As described above, after an ink image-receiving layer having a porous structure is formed on at least one surface of a support, and the support having the ink-image receiving layer is subjected to a calendar treatment with a long nip calendar which comprises a metal roll and a shoe roll, and a synthetic resin belt is disposed therebetween, having a nip width of 10 mm or more, thereby, the glossiness of the surface can be improved, and an ink blur can be suppressed, without destructing the porous structure in the ink image-receiving layer, that is, without deteriorating the ink absorbability.

### EXAMPLES

Examples of the present invention will be explained below, but the invention is not limited to these Examples at all. Hereafter, “%” and “part” means “% by mass” and “part by mass” unless otherwise specified.

### Example 1

### Preparation of Base Paper

A woodpulp consisting of 100 parts of LBKP as a pulp sample was beaten with a double disk refiner (blade type, clearance was suitably adjusted) to Canadian Freeness of 300 ml, 0.5 part of epoxylated behenic acid amide, 1.0 part of anionic polyacrylamide, 0.1 part of polyamidopolyamine epichlorohydrin and 0.5 part of cationic polyacrylamide were added thereto in terms of the absolute dry mass ratio of the pulp, and 15 parts (content (solid content of 12.8%) in the slurry of the pulp) of calcium carbonate as a filler was added to obtain a base paper having a basis weight of 150 g/m² using a fourdrinier paper machin.

Preparation of Pigment Coated Paper (Substrate Paper))

[Formation of Coated Layer]

A coating solution for a coated layer containing the following components was in line coated on the both surfaces of the resulting base paper in a solid amount of 20 g/m², and was dried to form a coated layer on the both surfaces of the base paper.

[Coating Solution for Coated Layer]

| | | |
|---|---|---|
| (1) Calcium carbonate | 50 | parts |
| (2) Clay (trade name: SATENTONE 5HB, manufactured by Hayashi Kasei) | 50 | parts |
| (3) MBR latex (trade name: NALSTAR MR-170, manufactured by Nippon A & L, 45%) | 12 | parts |
| (4) Polyvinyl alcohol (trade name: PVA-10, manufactured by Kurarey Co., Ltd.) | 5 | parts |
| (5) Ion exchanged water | 100 | parts |

### (Preparation of Resin-Coated Paper (Support))

Both surfaces of a felt side (front surface) and a wire side (back surface) of the base paper on which the coated layer had been formed were subjected to a corona discharge treatment, and 70 parts of a high density polyethylene containing 13.6 parts of anatase type titanium oxide and a small amount of ultramarine, and 70 parts of a low density polyethylene were coated at a thickness of 20 μm by using a heat melting extruder to form a polyolefin layer, so that a resin coated paper (substrate) having a glossy surface was obtained.

### (Preparation of Ink Image-Receiving Layer Coating Solution A)

(1) Vapor phase silica fine particles, (2) ion exchanged water and (3) “SHAROL DC-902P” in the following composition were mixed, the mixture was dispersed using a bead mill (trade name KD-P, manufactured by Shinmaru Enterprises), and a solution containing (4) polyvinyl alcohol, (5) boric acid, (6) polyoxyethylene lauryl ether and (7) ion exchanged water described below was added to prepare an ink image-receiving layer coating solution A. Thereupon, a mass ratio of the silica fine particles and thewater-soluble resin (PB ratio=(1):(4)) was 4.5:1, and a pH value of the ink image-receiving coating solution was acidic of 3.5.

[Composition of Ink Image-Receiving Layer Coating Solution A]

| | | |
|---|---|---|
| (1) Vapor method silica fine particles (inorganic fine particles) | 10.0 | parts |
| (RHEOSEAL QS30, manufactured by Tokuyama, average primary particle diameter 7 nm) | | |
| (2) Ion exchanged water | 51.6 | parts |
| (3) “SHAROL DC-902P” (51.5% aqueous solution) | 1.0 | part |
| (Dispersant, manufactured by Dai-ichi Kogyo Seiyaku Co., Ltd.) | | |
| (4) Polyvinyl alcohol (water-soluble resin) 8% aqueous solution | 27.8 | parts |
| (PVA124, manufactured by Kuraray Co., Ltd., saponification degree | | |
| 98.5%, polymerization degree 2400) | | |
| (5) Boric acid (crosslinking agent) | 0.4 | part |
| (6) Polyoxyethylene lauryl ether (surfactant) | 1.2 | parts |
| (trade name EMULGEN 109P (10% aqueous solution) manufactured | | |
| by Kao Corporation, HLB value 13.6) | | |
| (7) Ion exchanged water | 33.0 | parts |

After the front surface of the support was subjected to the corona discharge treatment, the ink image receiving layer coating solution A obtained in the above was coated on the front surface of the support in a coating amount of 200 ml/m² using an extrusion die coater (coating step), and was dried in a hot air drier at 80° C. (blow rate of 3 to 8 m/sec) until the solid content of the coated layer became 20%. This coated layer exhibited a constant rate drying rate during this period. Immediately after this step, the coated layer was immersed in a mordant solution B having the following composition for 30 seconds to adhere in an amount of 20 g/m² on the coated layer, and was further dried at 80° C. for 10 minutes (drying step). Thereby, an inkjet recording medium having an ink image-receiving layer having a dry layer thickness of 32 μm was produced.

[Composition of Mordant Solution B]

| | | |
|---|---|---|
| (1) Boric acid (crosslinking agent) | 0.65 | part |
| (2) Polyallylamine “PAA-03” 20% aqueous solution | 15.0 | parts |
| (Mordant, manufactured by Nittobo) | | |
| (3) Ion exchanged water | 72.0 | parts |
| (4) Ammonium chloride (surface pH adjusting agent) | 0.8 | part |
| (5) Polyoxyethylene lauryl ether (surfactant) | 10.0 | parts |
| (EMULGEN 109P, manufactured by Kao Corporation, 2% aqueous | | |
| solution, HLB value 13.6) | | |
| (6) Megafack “F1405” 10% aqueous solution | 2.0 | parts |
| (Fluorine-based surfactant manufactured by Dainippon | | |
| Ink and Chemicals, Incorporated) | | |

### (Calendar Treatment)

The resulting inkjet recording medium was passed through a long nip calendar provided with a metal roll having a surface temperature of 80° C., and a shoe roll having an endless belt made of an elastic resin at a nip width of 20 mm and a nip pressure of 150 kN/m at a speed of 200 m/min, in the state where the formed ink image-receiving layer was brought into contact with the metal roll, to perform a calendar treatment, thereby, an inkjet recording medium (1) was prepared.

### Example 2

According to the same manner as that of Example 1 except that the nip width in the calendar treatment was changed to 50 mm, an inkjet recording medium (2) was prepared.

### Example 3

According to the same manner as that of Example 2 except that 15.0 parts of polyallylamine “PAA-03” (20% aqueous solution) used in a mordant solution B was changed to 2.0 parts of ammonium zirconium carbonate (20% aqueous solution), and 0.8 part of ammonium chloride was changed to 1.0 part of ammonium carbonate in Example 2, an inkjet recording medium (3) was prepared.

### Example 4

According to the same manner as that of Example 1 except that the resin coated paper was changed to the following resin coated paper, 15.0 parts of polyallylamine “PAA-03” (20% aqueous solution) used in a mordant solution B was changed to 1.5 parts of ammonium zirconium carbonate (20% aqueous solution), 0.8 part of ammonium chloride was changed to 1.0 part of ammonium carbonate, and the surface temperature of the metal roll used in the calendar treatment was changed to 110° C., an inkjet recording medium (4) was prepared.

### (Preparation of Resin Coated Paper (Support))

After the both surfaces f the felt side (front surface) and the wire side (back surface) of the calendar-treated pigment-coated paper were subjected to a corona discharge treatment, 90 parts of polypropylene containing 13.6 parts of anatase type titanium oxide and a small amount of ultramarine, 7 parts of a high density polyethylene, and 3 parts of a low density polyethylene were coated by the use of a heat-melting extruder at a thickness of 20 μm, to prepare a resin coated paper (substrate) having a glossy surface.

### Example 5

According to the same manner as that of Example 1 except that the resin coated paper was changed to the following resin coated paper, the nip width in the calendar treatment was changed to 50 mm, and the surface temperature of the metal roll used in the calendar treatment was changed to 130° C., an inkjet recording medium (5) was prepared.

### (Preparation of Resin Coated Paper (Support))

After the both surfaces of the felt side (front surface) and the wire side (back surface) of a calendar-treated pigment-coated paper were subjected to a corona discharge treatment 90 parts of polypropylene containing 13.6 parts of anatase type titanium oxide and a small amount of ultramarine, 7 parts of a high density polyethylene, and 3 parts of a low density polyethylene were coated by the use of a heat-melting extruder at a thickness of 20 μm, to prepare a resin coated paper (substrate) having a glossy surface.

### Example 6

According to the same manner as that of Example 1 except that the resin coated paper was changed to the following resin coated paper, 15.0 parts of polyallylamine “PAA-03” (20% aqueous solution) used in the mordant solution B was changed to 2.0 parts of ammonium zirconium carbonate (20% aqueous solution), 0.8 part of ammonium chloride was changed to 1.0 part of ammonium carbonate, the nip width in the calendar treatment was changed to 30 mm, and the surface temperature of the metal roll used in the calendar treatment was changed to 130° C., an inkjet recording medium (6) was prepared. [0126]

### (Preparation of Resin Coated Paper (Support))

After the both surfaces of the felt side (front surface) and the wire side (back surface) of the calendar-treated pigment-treated paper were subjected to a corona discharge treatment, 90 parts of polypropylene containing 13.6 parts of anatase type titanium oxide and a small amount of ultramarine, 7 parts of a high density polyethylene, and 3 parts of a low density polyethylene were coated by the use of a heat-melting extruder at a thickness of 20 μm, to prepare a resin coated paper (substrate) having a glossy surface.

### Comparative Example 1

According to the same manner as that of Example 1 except that the calendar treatment was not performed, an inkjet recording medium (7) was prepared.

### Comparative Example 2

According to the same manner as that of Example 1 except that the condition of the calendar treatment was changed to the following calendar treatment condition, an inkjet recording medium (8) was prepared.

### (Calendar Treatment)

The resulting inkjet recording medium was subjected to a calendar treatment, in which the inkjet recording medium was passed through nips in a supercalendar having three combinations of a metal roll having a surface temperature of 80° C. and an elastic cotton roll at a nip width of 3 mm and a nip pressure of 150 kN/m for each combination at a rate of 200 m/min, in the state where the surface of the recording medium on which the ink image-receiving layer is formed was brought into contact with each aforementioned metal roll.

### Comparative Example 3

According to the same manner as that of Example 1 except that the condition of the calendar treatment was changed to the following calendar treatment condition, an inkjet recording medium (9) was prepared.

### (Calendar Treatment)

The resulting inkjet recording medium was subjected to a calendar treatment, in which the inkjet recording medium was passed through a nip having a nip width of 5 mm and a nip pressure of 150 kN/m in a soft calendar having a metal roll having a surface temperature of 130° C. and an elastic resin (urethane-based) roll at a speed of 200 m/min., in the state where the surface of the recording medium on which the ink image-receiving layer is formed was brought into contact with the metal roll.

### Comparative Example 4

According to the same manner as that of Example 1 except that the resin coated paper was changed to the following resin coated paper, and the condition of the calendar treatment was changed to the following calendar treatment condition, an inkjet recording a medium (10) was prepared.

### (Preparation of Resin Coated Paper (Support))

After the both surfaces of the felt side (front surface) and the wire side (back surface) of the calendar-treated pigment-coated paper were subjected to a corona discharge treatment, 90 parts of polypropylene containing 13.6 parts of anatase type titanium oxide and a small amount of ultramarine, 7 parts of a high density polyethylene, and 3 parts of a low density polyethylene were coated by the use of a heat-melting extruder at a thickness of 20 μm, to prepare a resin coated paper (substrate) having a glossy surface.

### (Calendar Treatment)

The resulting inkjet recording medium was passed through a nip width of 1 mm and a nip pressure of 150 kN/m, in a machine calendar having a pair of metal rolls having a surface temperature of 130° C. at a rate of 200 m/min, in the state where the surface on which an ink image-receiving layer was formed was brought into contact with the metal roll, to perform a calendar treatment.

### Comparative Example 5

According to the same manner as that of Example 1 except that after the coated layers were formed on the both surfaces of a base paper, the following calendar treatment was performed, thereafter, the both surfaces were subjected to a corona discharge-treatment, and further, a calendar treatment after the ink image-receiving layer was formed, was not performed, an inkjet recording medium (11) was prepared.

### (Calendar Treatment)

The resulting base paper having coated layers on the both surfaces thereof was passed through a nip width of 50 mm and a nip pressure of 150 kN/m, in a long nip calendar having a metal roll having a surface temperature of 150° C. and a shoe roll having an endless belt made of an elastic resin, at a rate of 200 m/min. in the state where the surface on which an ink image-receiving layer was formed was brought into contact with the metal roll, to perform a calendar treatment.

### (Evaluation)

Each of inkjet recording media of Examples and Comparative Examples obtained in the above was evaluated as follows. The evaluation results together with manufacturing conditions are shown in Table 1. In a column of a polyolefin layer in Table 1, “PE” stands for polyethylene, “PP” stands for polypropylene, and the mass ratios of PE and PP are shown in ( ).

### (1) Gloss Feeling

A gloss (gloss degree) at a measuring angle of 20 degree in an ink image-receiving layer surface of an inkjet recording medium before printing was measured with a digital angle-varying glossmeter (UGV-50DP, manufactured by Suga Test Instrument Co. Ltd.). In addition, the evaluation was performed from the measured values in accordance with the following criteria. Numerical values in ( ) show measured values of the gloss degree.

[Criteria]

| | |
|---|---|
| 5: Excellent gloss feeling. | (21% or more) |
| 4: Good Gloss feeling | (17% or more and less than 21%) |
| 3: Gloss feeling is slightly inferior, but in an acceptable range | (13% ore more and less than 17%) |
| 2: Gloss feeling is inferior (not acceptable range) | (9% or more and less than 13%) |
| 1: Gloss feeling is remarkably inferior. | (less than 9%) |

(2) Ink blur

A magenta ink and a cyan ink were printed on a surface of each inkjet recording medium on which an ink-receiving layer was provided at 1 cm intervals using an inkjet printer (PM-900C, manufactured by Seiko Epson), was allowed to stand in a room for 48 hours, and the ink blur thereof was observed, and evaluated according to the following criteria.

[Criteria]
5: An ink blur was not observed at all.
4: A very slight ink blur was observed.
3: An ink blur was observed, but within an acceptable range.
2: An ink blur was striking, and outside an acceptable range.
1: An ink blur was remarkable.

TABLE 1

| | | Layer curing | Calendar treatment after formation of ink image-receiving layer | | | | | | |
|---|---|---|---|---|---|---|---|---|---|
| | | agent aid in ink | | | Nip | Nip | Temperature of | | |
| | Polyolefin | image-receiving | | Passage rate | pressure | width | metal roll | Evaluation results | |
| | resin layer | layer | Kind | [m/min] | [kN/m] | [mm] | surface | Ink blur | Gloss feeling |
| Example 1 | PE | Polyallylamine | Long nip | 200 | 150 | 20 | 80 | 5 | 3 |
| | | | calendar | | | | | | |
| Example 2 | PE | Polyallylamine | Long nip | 200 | 150 | 50 | 80 | 5 | 4 |
| | | | calendar | | | | | | |
| Example 3 | PE | Ammonium | Long nip | 200 | 150 | 50 | 80 | 5 | 5 |
| | | zirconium | calendar | | | | | | |
| | | carbonate | | | | | | | |
| Example 4 | PP and PE | Ammonium | Long nip | 200 | 150 | 20 | 110 | 5 | 4 |
| | (PP:PE = 9:1) | zirconium | calendar | | | | | | |
| | | carbonate | | | | | | | |
| Example 5 | PP and PE | Polyallylamine | Long nip | 200 | 150 | 50 | 130 | 5 | 4 |
| | (PP:PE = 9:1) | | calendar | | | | | | |
| Example 6 | PP and PE | Ammonium | Long nip | 200 | 150 | 30 | 130 | 5 | 5 |
| | (PP:PE = 9:1) | zirconium | calendar | | | | | | |
| | | carbonate | | | | | | | |
| Comparative | PE | Polyallylamine | — | — | — | — | — | 5 | 1 |
| Example 1 | | | | | | | | | |
| Comparative | PE | Polyallylamine | Supercalendar | 200 | 150 | 3 | 80 | 2 | 2 |
| Example 2 | | | | | | | | | |
| Comparative | PE | Polyallylamine | Soft calendar | 200 | 150 | 5 | 130 | 2 | 1 (Blister |
| Example 3 | | | | | | | | | occurred) |
| Comparative | PP and PE | Polyallylamine | Machine | 200 | 150 | 1 | 130 | 1 | 2 |
| Example 4 | (PP:PE = 9:1) | | calendar | | | | | | |
| Comparative | PE | Polyallylamine | — | — | — | — | — | 5 | 2 |
| Example 5 | | | | | | | | | |

As apparent from Table 1, it is seen that, in the inkjet recording media (1) to (6) of the invention obtained by forming an ink image-receiving layer of a porous structure, followed by subjecting thereof to the calendar treatment by the use of the long nip calendar having a nip width of 10 mm or more, an ink blur is suppressed, and gloss feeling is better.

### INDUSTRIAL APPLICABILITY

According to the present invention, an inkjet recording medium having an excellent ink absorbability, a suppressed ink blur, and an excellent surface glossiness is provided, and a process for manufacturing the inkjet recording medium is provided.

1. A process for manufacturing an inkjet recording medium having an ink image-receiving layer having a porous structure on at least one surface of a support, comprising:
forming the ink image-receiving layer having a porous structure on at least one surface of the support, and
subjecting the support having the ink image-receiving layer to a calendar treatment by the use of a long nip calendar comprising a metal roll and a shoe roll with a synthetic resin belt therebetween and having a nip width of 10 mm or more.

2. The process for manufacturing an inkjet recording medium of claim 1, wherein the ink image-receiving layer contains ammonium zirconium carbonate.

3. The process for manufacturing an inkjet recording medium of claim 1, wherein the support is a paper support in which both surfaces of a base paper are coated with a polyolefin resin.

4. The process for manufacturing an inkjet recording medium of claim 2, wherein the support is a paper support in which both surfaces of a base paper are coated with a polyolefin resin.

5. The process for manufacturing an inkjet recording medium of claim 3, wherein the polyolefin resin on at least one surface of the support on which the ink image-receiving layer is provided, is a resin containing 50% by mass or more of polypropylene.

6. The process for manufacturing an inkjet recording medium of claim 4, wherein the polyolefin resin on at least one surface of the support on which the ink image-receiving layer is provided, is a resin containing 50% by mass or more of polypropylene.

7. The process for manufacturing an inkjet recording medium of claim 1, wherein the surface temperature of the side of the metal roll which is brought into contact with the ink image-receiving layer, when the calendar treatment is performed, is 50 to 170° C.

8. The process for manufacturing an inkjet recording medium of claim 2, wherein the surface temperature of the side of the metal roll which is brought into contact with the ink image-receiving layer, when the calendar treatment is performed, is 50 to 170° C.

9. The process for manufacturing an inkjet recording medium of claim 3, wherein the surface temperature of the side of the metal roll which is brought into contact with the ink image-receiving layer, when the calendar treatment is performed, is 50 to 170° C.

10. The process for manufacturing an inkjet recording medium of claim 5, wherein the surface temperature of the side of the metal roll which is brought into contact with the ink image-receiving layer, when the calendar treatment is performed, is 50 to 170° C.

11. The process for manufacturing an inkjet recording medium of claim 1, wherein the nip width is 20 mm or more, the polyolefin resin is a resin containing 50% by mass or more of polypropylene, the surface temperature of the side of the metal roll which is brought into contact with the ink image-receiving layer, when the calendar treatment is performed, is from 80 to 170° C., and the nip pressure between the metal roll and the shoe roll is from 50 to 300 kN/m.

12. The process for manufacturing an inkjet recording medium of claim 6, wherein the nip width is 20 mm or more, the polyolefin resin is a resin containing 50% by mass or more of polypropylene, the surface temperature of the side of the metal roll which is brought into contact with the ink image-receiving layer, when the calendar treatment is performed, is from 80 to 170° C., and the nip pressure between the metal roll and the shoe roll is from 50 to 300 kN/m.

13. The process for manufacturing an inkjet recording medium of claim 8, wherein the nip width is 20 mm or more, the polyolefin resin is a resin containing 50% by mass or more of polypropylene, the surface temperature of the side of the metal roll which is brought into contact with the ink image-receiving layer, when the calendar treatment is performed, is from 80 to 170° C., and the nip pressure between the metal roll and the shoe roll is from 50 to 300 kN/m.

14. The process for manufacturing an inkjet recording medium of claim 7, wherein the nip width is 20 mm or more, the polyolefin resin is a resin containing 50% by mass or more of polypropylene, the surface temperature of the side of the metal roll which is brought into contact with the ink image-receiving layer, when the calendar treatment is performed, is from 80 to 170° C., and the nip pressure between the metal roll and the shoe roll is from 50 to 300 kN/m.

15. The process for manufacturing an inkjet recording medium of claim 9, wherein the nip width is 20 mm or more, the polyolefin resin is a resin containing 50% by mass or more of polypropylene, the surface temperature of the side of the metal roll which is brought into contact with the ink image-receiving layer, when the calendar treatment is performed, is from 80 to 170° C., and the nip pressure between the metal roll and the shoe roll is from 50 to 300 kN/m.

16. The process for manufacturing an inkjet recording medium of claim 10, wherein the nip width is 20 mm or more, the polyolefin resin is a resin containing 50% by mass or more of polypropylene, the surface temperature of the side of the metal roll which is brought into contact with the ink image-receiving layer, when the calendar treatment is performed, is from 80 to 170° C., and the nip pressure between the metal roll and the shoe roll is from 50 to 300 kN/m.

17. An inkjet recording medium, manufactured by the process for manufacturing an inkjet recording medium of claim 1.

18. An inkjet recording medium, manufactured by the process for manufacturing an inkjet recording medium of claim 11.

19. An inkjet recording medium, manufactured by the process for manufacturing an inkjet recording medium of claim 14.

20. An inkjet recording medium, manufactured by the process for manufacturing an inkjet recording medium of claim 16.
